(19) United States
(12) Patent Application Publication
(10) Pub. No.: US 2013/0112672 A1
(43) Pub. Date: May 9, 2013

(54) LASER CONFIGURATION FOR ADDITIVE MANUFACTURING

(71) Applicants: John J. Keremes, Canoga Park, CA (US); Jeffrey D. Haynes, Canoga Park, CA (US); Youping Gao, Canoga Park, CA (US); Daniel Edward Matejczyk, Canoga Park, CA (US)

(72) Inventors: John J. Keremes, Canoga Park, CA (US); Jeffrey D. Haynes, Canoga Park, CA (US); Youping Gao, Canoga Park, CA (US); Daniel Edward Matejczyk, Canoga Park, CA (US)

(21) Appl. No.: 13/362,322

(22) Filed: Jan. 31, 2012

Related U.S. Application Data
(60) Provisional application No. 61/556,990, filed on Nov. 8, 2011.

(51) Int. Cl. B23K 26/00

(52) U.S. Cl. 219/121.78

(57) ABSTRACT

An additive manufacturing assembly includes a work space including a plurality of separate regions and an energy transmitting device for focusing an energy beam to a specific location within one of the plurality of regions within the work space. The energy transmitting device includes features for expanding the workspace for fabricating parts of increased size and volume.

### CROSS REFERENCE TO RELATED APPLICATION

This application claims priority to U.S. Provisional Application No. 61/556,990 that was filed on Nov. 8, 2011.

### BACKGROUND

This disclosure generally relates to an LASER configuration for an additive manufacturing machine and process. More particularly, this disclosure relates to a LASER configuration for improving coverage area for increasing possible overall part area and volume.

Typical manufacturing methods include various methods of removing material from a starting blank of material to form a desired completed part shape. Such methods utilize cutting tools to remove material to form holes, surfaces, overall shapes and more by subtracting material from the starting material. Such subtractive manufacturing methods impart physical limits on the final shape of a completed part. Additive manufacturing methods form desired part shapes by adding one layer at a time and therefore provide for the formation of part shapes and geometries that would not be feasible in part constructed utilizing traditional subtractive manufacturing methods.

Additive manufacturing utilizes a heat source such as a laser beam to melt layers of powdered metal to form the desired part configuration layer upon layer. The laser forms a melt pool in the powdered metal that solidifies. Another layer of powdered material is then spread over the formerly solidified part and melted to the previous melted layer to build a desired part geometry layer upon layer.

The size and shape of a part formed by additive manufacturing is dependent on the size of the envelope in which the laser can be applied to a surface. The range in which a laser can generate a desired focal point can limit the additive manufacturing space and thereby the feasible size of a desired part.

### SUMMARY

An additive manufacturing assembly according to an exemplary embodiment of this disclosure, among other possible things includes a work space including a plurality of separate regions, an energy transmitting device for focusing an energy beam to a specific location within one of the plurality of regions within the work space, and a splitter for dividing the energy beam to focus energy to a location within at least two of the plurality of separate regions of the work space.

In a further embodiment of the foregoing additive manufacturing assembly, the splitter simultaneously divides the energy beam into each of the plurality of regions within the work space.

In a further embodiment of any of the foregoing additive manufacturing assemblies, the splitter directs each of the energy beams separately within each of the plurality of regions.

In a further embodiment of any of the foregoing additive manufacturing assemblies, the splitter comprise a plurality of directing features controllable for focusing energy from the energy transmitting device within each of the plurality of separate regions.

In a further embodiment of any of the foregoing additive manufacturing assemblies, the energy-transmitting device comprises a Laser beam.

A method of additive manufacturing according to an exemplary embodiment of this disclosure, among other possible things includes the steps of defining a work space including a plurality of regions, defining a part configuration, applying a layer of material over the work space, splitting a single energy beam into a plurality of energy beams, and directing each of the plurality of energy beams into the work space for melting the material within the work space according to the defined part configuration.

In a further embodiment of the foregoing additive manufacturing method including splitting the energy beam such that one of the plurality of energy beams is directed simultaneously into each of the plurality of regions within the work space.

In a further embodiment of any of the foregoing additive manufacturing methods further including separately controlling each of the energy beams within each of the plurality of regions.

An additive manufacturing assembly according to another exemplary embodiment including, among other things, a work space including a plurality of separate regions, an energy transmitting device for focusing an energy beam to a specific location within the work space, and a transit supporting the energy transmitting device, the transit movable relative to the work space for positioning the energy transmitting device relative to the workspace for focusing the energy beam within each of the plurality of separate regions.

In a further embodiment of the foregoing additive manufacturing assembly a controller governs movement of the transit relative to the workspace.

In a further embodiment of any of the foregoing additive manufacturing assemblies, the energy transmitting device produces a plurality of separate energy beams that focus energy separately on different regions within the workspace.

In a further embodiment of any of the foregoing additive manufacturing assemblies, the energy transmitting device comprises a plurality of separately controllable energy transmitting devices.

An additive manufacturing assembly according to another exemplary embodiment including, among other things, a workspace including a plurality of separate regions, a plurality of energy transmitting devices corresponding with the plurality of separate regions of the workspace, each of the plurality of energy transmitting devices separately controllable for focusing an energy beam within the workspace, and a controller for coordinating actuation of the plurality of energy transmitting devices.

The additive manufacturing assembly of the foregoing embodiment, including overlapping zones between adjacent ones of the plurality of separate regions of the workspace and each of the plurality of energy transmitting devices are arranged to transmit energy within the corresponding overlapping zones.

The additive manufacturing assembly of any of the foregoing embodiments wherein each of the plurality of energy transmitting devices directs energy to a surface of a corresponding one of the separate regions of the workspace.

A method of additive manufacturing according to another exemplary embodiment including, among other things, the steps of defining a work space including a plurality of regions, defining a part configuration, applying a layer of material over the work space and directing a plurality of energy beams into the work space for melting the material within the work space according to the defined part configuration.

The method of additive manufacturing according to the foregoing embodiment, including directing each of the plurality of energy beams into separate ones of the plurality of regions and separately controlling each of the plurality of energy beams independent of the other ones of the plurality of energy beams.

The method of additive manufacturing according to any of the foregoing embodiments including defining overlapping regions between each of the plurality of regions defined in the workspace and controlling each of the plurality of energy beams to direct energy into corresponding overlapping regions.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic perspective view of an additive manufacturing assembly.

FIG. 2 is a side schematic view of the example additive manufacturing assembly.

FIG. 3 is a top schematic view of another example additive manufacturing assembly.

FIG. 4 is a side schematic view of the example additive manufacturing assembly shown in FIG. 3.

FIG. 5 is a top schematic view of another additive manufacturing assembly.

FIG. 6 is a side view of the example additive manufacturing assembly shown in FIG. 5.

### DETAILED DESCRIPTION

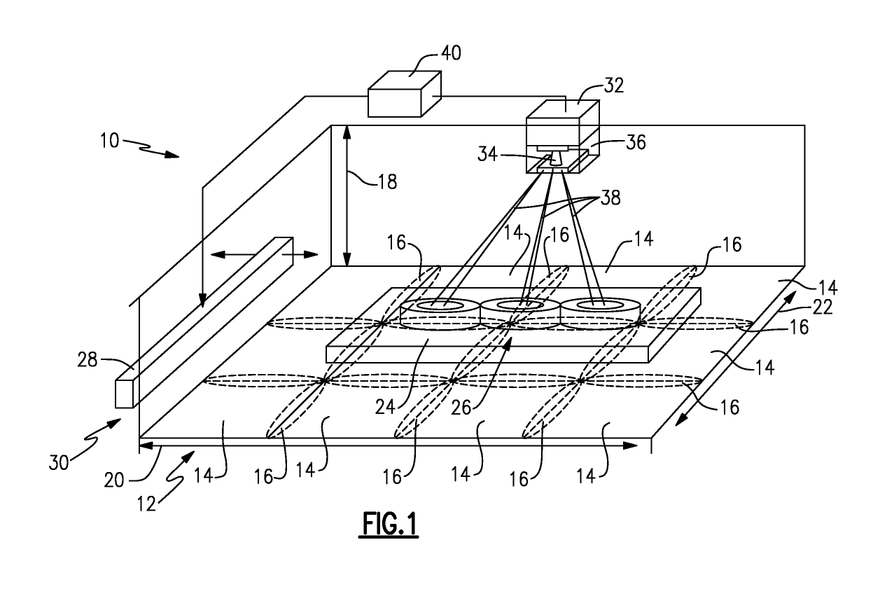

Referring to FIG. 1, an example additive manufacturing assembly 10 includes a workspace 12, an energy-directing device 32 that emits an energy beam 34, a material dispersal device 28, and a controller 40. The example energy-directing device 32 emits a laser beam 34 into the workspace for melting portions of material 30 spread over a support 24 provided in the workspace 12. The example assembly 10 provides for the fabrication of an example part 26 layer by layer by repeated and subsequent melting of layers of material set out by the dispersal device 28. In this example, the dispersal device 28 lays a layer of metal powder of a composition desired for the completed part 26. It should be understood that other material are also within the contemplation of this disclosure.

The example workspace 12 is divided into a plurality of regions 14 with overlapping regions 16 disposed between adjacent ones of the regions 14. The example workspace 12 includes a width 22, a length 20, and a height 18. The volume and space provided within the workspace 12 has been limited in the past by the capabilities of the energy-transmitting device 32. In this example, the energy-transmitting device 32 emits a single primary beam 34 that is directed through a splitter 36. The splitter 36 divides the primary beam 34 into a plurality of secondary beams 38 that are separately and independently directed to different regions 14 within the workspace 12. Direction of the various beams 38 is governed by the configuration of the part and controlled by the controller 40 in conjunction with operation of the powder dispersal device 28.

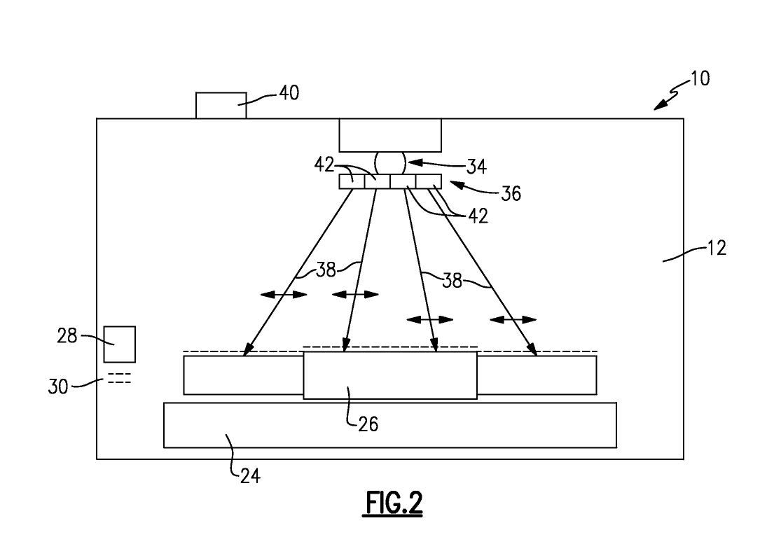

Referring to FIG. 2, with continued reference to FIG. 1, the example energy-transmitting device 32 transmits the primary beam 34 that in this example is a laser beam through the splitter 36 to generate a plurality of secondary beams 38. The splitter 36 includes a plurality of energy directing elements 42. Each of the energy directing elements 42 are individually movable in response to directions from the controller 40 to direct each of the secondary beams 38 into separate regions 14 of the workspace 12. Splitting the main beam 34 into a plurality of secondary beams 36 provides for the fabrication of a part 26 with larger dimensions and greater volume within the increased size of the example workspace 12 over a workspace limited to only single energy beam.

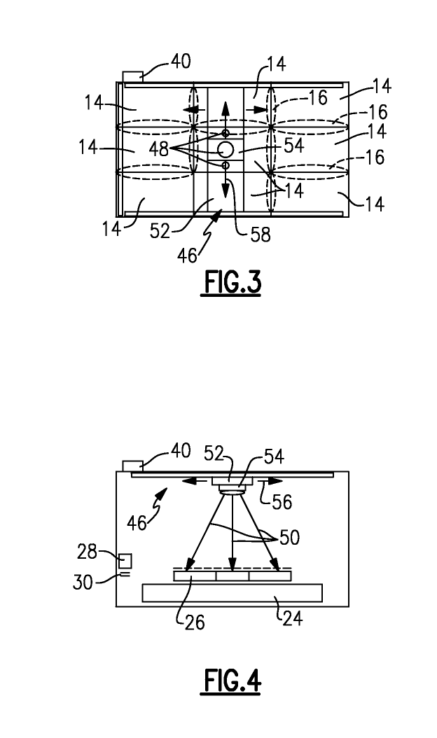

Referring to FIGS. 3 and 4, another example additive manufacturing device 44 includes energy transmitting devices 48 supported on a transit assembly 46. In this example, the energy transmitting devices 48 emit a laser beam 50. The transit assembly 46 provides for movement of the laser beams 50 throughout the workspace 12 to increase the overall range in which energy can be directed over the desired part 26. The increased range provides for an increased size and volume of a part that may be fabricated within the workspace 12. In this example, the transit 46 includes a first carriage 52 that moves along a width of the workspace 12 in a first direction indicated by arrows 56. The transit 46 also includes a second carriage 54 that moves on the first carriage 52 in a second direction indicated by arrows 58. Movement of the transit 52 throughout the workspace 12 provides for increases in the workspace area 12 and thereby provides for fabrication of parts with an increased size and volume.

In this example, a plurality of laser transmitting devices 48 are supported on the second carriage 54, however a single laser transmitting device 48 is also within the contemplation of this disclosure. Each of the plurality of laser transmitting devices 48 emit a separate laser beam 50 that is independently and separately movable for directing energy over separate portions of the part 26. This independent direction of energy provides for the desired increased volume of a desired part configuration 26. The controller 40 governs operation of the transit 46 and each of the plurality of laser beams 48 within the workspace 12 to coordinate selective melting of the powder metal material 30 in different locations to create the desired part.

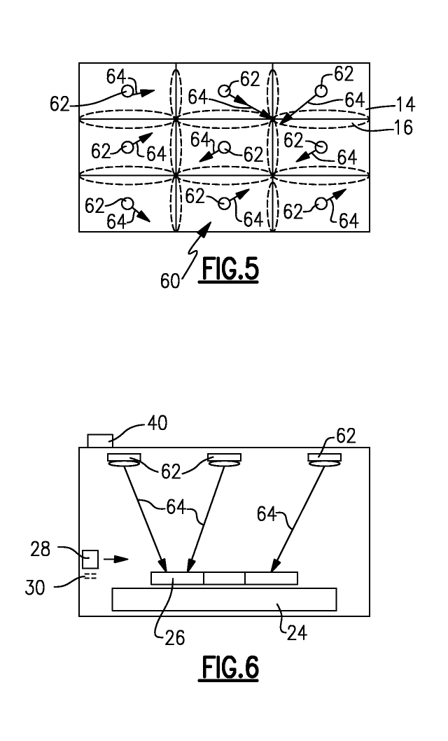

Referring to FIGS. 5 and 6, another disclosed example additive manufacturing system 60 includes a plurality of energy directing devices 62 that direct laser beams 64 within a corresponding one of the regions 14 of within the workspace 12. The multiple energy beams 62 are separately and independently movable to direct energy within the corresponding region 14 while beams in other regions 14 are also generating and melting powdered material to form a part according to a predefined part configuration. Multiple, separate concurrently acting laser beams 64 increase the reasonable part size and volume that can be fabricated within a reasonable period.

In this example, each of the laser beams 64 is adapted to be directed into a corresponding overlapping area 16. The overlapping areas 16 include a portion of area within adjacent regions 14. The overlapping extension of each of the laser beams 64 provides for a consistent melting of powdered metal at the boundaries separating the regions. The overlapping portions 16 and melting provided by adjacent beams 64 in adjacent regions 14 prevents undesired incomplete melting, or possible knit lines within a completed part. In other words, each of the laser beams 64 are capable of being directed to the overlapping region such that the part fabricated will include a complete melting and coverage of the metal powder during formation of a desired part configuration.

Accordingly, the disclosed example additive manufacturing devices provide for the increase in workspace size, thereby providing for a corresponding increase in possible part size and volume that can be produced within a reasonable time.

Although an example embodiment has been disclosed, a worker of ordinary skill in this art would recognize that certain modifications would come within the scope of this disclosure. For that reason, the following claims should be studied to determine the scope and content of this invention.

What is claimed is:

1. An additive manufacturing assembly comprising:
a work space including a plurality of separate regions;
an energy transmitting device for focusing an energy beam to a specific location within one of the plurality of regions within the work space; and
a splitter for dividing the energy beam to focus energy to a location within at least two of the plurality of separate regions of the work space.

2. The additive manufacturing assembly as recited in claim 1, wherein the splitter simultaneously divides the energy beam into each of the plurality of regions within the work space.

3. The additive manufacturing assembly as recited in claim 2, wherein the splitter directs each of the energy beams separately within each of the plurality of regions.

4. The additive manufacturing assembly as recited in claim 3, wherein the splitter comprise a plurality of directing features controllable for focusing energy from the energy transmitting device within each of the plurality of separate regions.

5. The additive manufacturing assembly as recited in claim 1, wherein the energy-transmitting device comprises a Laser beam.

6. A method of additive manufacturing comprising the steps of:
defining a work space including a plurality of regions;
defining a part configuration;
applying a layer of material over the work space;
splitting a single energy beam into a plurality of energy beams; and
directing each of the plurality of energy beams into the work space for melting the material within the work space according to the defined part configuration.

7. The method of additive manufacturing as recited in claim 6, including splitting the energy beam such that one of the plurality of energy beams is directed simultaneously into each of the plurality of regions within the work space.

8. The method of additive manufacturing as recited in claim 6, including separately controlling each of the energy beams within each of the plurality of regions.

9. An additive manufacturing assembly comprising:
a work space including a plurality of separate regions;
an energy transmitting device for focusing an energy beam to a specific location within the work space; and
a transit supporting the energy transmitting device, the transit movable relative to the work space for positioning the energy transmitting device relative to the workspace for focusing the energy beam within each of the plurality of separate regions.

10. The additive manufacturing assembly as recited in claim 9, including a controller for governing movement of the transit relative to the workspace.

11. The additive manufacturing assembly as recited in claim 9, wherein the energy transmitting device produces a plurality of separate energy beams that focus energy separately on different regions within the workspace.

12. The additive manufacturing assembly as recited in claim 9, wherein the energy transmitting device comprises a plurality of separately controllable energy transmitting devices.

13. An additive manufacturing assembly comprising:
a workspace including a plurality of separate regions;
a plurality of energy transmitting devices corresponding with the plurality of separate regions of the workspace, each of the plurality of energy transmitting devices separately controllable for focusing an energy beam within the workspace; and
a controller for coordinating actuation of the plurality of energy transmitting devices.

14. The additive manufacturing assembly as recited in claim 13, including overlapping zones between adjacent ones of the plurality of separate regions of the workspace and each of the plurality of energy transmitting devices are arranged to transmit energy within the corresponding overlapping zones.

15. The additive manufacturing assembly as recited in claim 14, wherein each of the plurality of energy transmitting devices directs energy to a surface of a corresponding one of the separate regions of the workspace.

16. A method of additive manufacturing comprising the steps of:
defining a work space including a plurality of regions;
defining a part configuration;
applying a layer of material over the work space;
directing a plurality of energy beams into the work space for melting the material within the work space according to the defined part configuration.

17. The method of additive manufacturing as recited in claim 16, including directing each of the plurality of energy beams into separate ones of the plurality of regions and separately controlling each of the plurality of energy beams independent of the other ones of the plurality of energy beams.

18. The method of additive manufacturing as recited in claim 17, including defining overlapping regions between each of the plurality of regions defined in the workspace and controlling each of the plurality of energy beams to direct energy into corresponding overlapping regions.
